(19) United States
(12) Patent Application Publication
(10) Pub. No.: US 2025/0323260 A1
(43) Pub. Date: Oct. 16, 2025

(54) POSITIVE ELECTRODE PLATE AND NON-AQUEOUS ELECTROLYTE SECONDARY BATTERY HAVING THE SAME

(71) Applicant: Prime Planet Energy & Solutions, Inc., Tokyo (JP)

(72) Inventors: Kouhei MASAI, Kobe-shi (JP); Ryo HANAZAKI, Kobe-shi (JP)

(21) Appl. No.: 19/096,718

(22) Filed: Apr. 1, 2025

(30) Foreign Application Priority Data
Apr. 15, 2024 (JP) 2024-065633

(51) Int. Cl. H01M 4/525; H01M 4/02; H01M 4/131; H01M 4/36; H01M 4/62

(52) U.S. Cl. CPC H01M 4/525; H01M 4/131; H01M 4/366; H01M 4/623; H01M 4/625; H01M 2004/021; H01M 2004/028

(57) ABSTRACT

A positive electrode plate comprises a current collector, and an active material layer provided on the current collector. The active material layer has a first layer mainly composed of a first active material represented by a formula (I) and a second layer mainly composed of a second active material represented by a formula (II), and the second layer is positioned closer to the current collector than the first layer is. The formula (I) and the formula (II) are as defined in the claims. A content ratio between the first active material and the second active material in the active material layer is (first active material):(second active material)=2.5:7.5 to 6.5:3.5 (in weight). A porosity of the first layer is from 20 to 45%, and a porosity of the second layer is from 18 to 41%.

### CROSS REFERENCE TO RELATED APPLICATIONS

This nonprovisional application is based on Japanese Patent Application No. 2024-065633 filed on Apr. 15, 2024, with the Japan Patent Office, the entire contents of which are hereby incorporated by reference.

### BACKGROUND OF THE INVENTION

### Field of the Invention

The present invention relates to a positive electrode plate and a non-aqueous electrolyte secondary battery having the same.

### Description of the Background Art

It is known to use a positive electrode plate comprising a lithium-(transition metal) composite oxide as a positive electrode active material, on a current collector in a secondary battery. Japanese Patent Laying-Open No. 2015-115244 discloses a positive electrode for a secondary battery, comprising two layers that are different in the molar ratio of lithium to transition metal.

### SUMMARY OF THE INVENTION

Secondary batteries are demanded to have high capacity and low resistance.

The present disclosure aims at providing a positive electrode plate that can produce a high-capacity low-resistance non-aqueous electrolyte secondary battery, and a non-aqueous electrolyte secondary battery having the same.
[1] A positive electrode plate comprising:
a current collector; and
an active material layer provided on the current collector, wherein
the active material layer has
   a first layer mainly composed of a first active material represented by a formula (I) below, and
   a second layer mainly composed of a second active material represented by a formula (II) below, the second layer is positioned closer to the current collector than the first layer is,
a content ratio between the first active material and the second active material in the active material layer is (first active material):(second active material)=2.5:7.5 to 6.5:3.5 (in weight),
a porosity of the first layer is from 20 to 45%, and
a porosity of the second layer is from 18 to 41%:

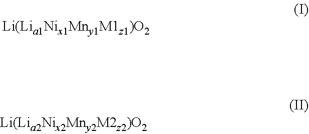

where
M1 and M2 are independently one or more metallic elements selected from the group consisting of Co, Al, Mg, Ca, Ti, V, Cr, Fe, Cu, Zn, Zr, Nb, Mo, Ta, and W,
0.1≤a1≤0.33, 0≤x1≤0.5, 0.5≤y1≤0.7, 0≤z1≤0.2, and a1+x1+y1+z1=1 are satisfied, and,
−0.1≤a2≤0.1, 0.5≤x2≤1, 0≤y2≤0.3, 0≤z2≤0.3, and a2+x2+y2+z2=1 are satisfied.
[2] The positive electrode plate according to [1], wherein the content ratio between the first active material and the second active material in the active material layer is (first active material):(second active material)=3:7 to 6:4 (in weight).
[3] The positive electrode plate according to [1] or [2], wherein the content ratio between the first active material and the second active material in the active material layer is (first active material):(second active material)=3:7 to 5:5 (in weight).
[4] The positive electrode plate according any one of [1] to [3], wherein each of the porosity of the first layer and the porosity of the second layer is from 20 to 40%.
[5] The positive electrode plate according to any one of [1] to [4], wherein the first layer constitutes a surface of the active material layer on a side opposite to a side on which the current collector is positioned.
[6] The positive electrode plate according to any one of [1] to [5], wherein the second layer is in contact with the current collector.
[7] The positive electrode plate according to any one of [1] to [6], wherein the second active material is a mixture of [p1] below and [p2] below:
[p1] at least one of single particles and secondary particles, the secondary particles each consisting of 2 to 10 primary particles aggregated together; and
[p2] secondary particles each consisting of at least 50 primary particles aggregated together.
[8] A non-aqueous electrolyte secondary battery comprising the positive electrode plate according to any one of [1] to [7].

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view schematically illustrating an example of a positive electrode plate according to an embodiment.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Positive Electrode Plate)

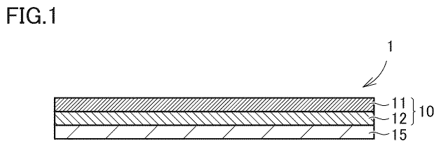

FIG. 1 is a cross-sectional view schematically illustrating an example of a positive electrode plate according to an embodiment. The positive electrode plate according to the present embodiment is used in a non-aqueous electrolyte secondary battery (hereinafter also called “a secondary battery”) such as a lithium-ion battery.

A positive electrode plate 1 has a current collector 15, and an active material layer 10 provided on current collector 15. Active material layer 10 has a first layer 11 mainly composed of a first active material represented by a formula (I) below, and a second layer 12 mainly composed of a second active material represented by a formula (II) below. Second layer 12 is positioned closer to current collector 15 than first layer 11 is. The content ratio between the first active material and the second active material in active material layer 10 is (first active material):(second active material)=2.5:7.5 to 6.5:3.5 (in weight). The porosity of the first layer is from 20 to 45%, and the porosity of the second layer is from 18 to 41%.

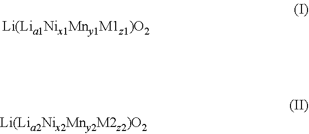

[In the formula (I) and the formula (II),
M1 and M2 are independently one or more metallic elements selected from the group consisting of Co, Al, Mg, Ca, Ti, V, Cr, Fe, Cu, Zn, Zr, Nb, Mo, Ta, and W,
0.1≤a1≤0.33, 0≤x1≤0.5, 0.5≤y1≤0.7, 0≤z1≤0.2, and a1+x1+y1+z1=1 are satisfied, and,
−0.1≤a2≤0.1, 0.5≤x2≤1, 0≤y2≤0.3, 0≤z2≤0.3, and a2+x2+y2+z2=1 are satisfied.]

Each of the first active material and the second active material is a lithium-(transition metal) composite oxide. The first active material is a lithium-rich positive electrode active material with a high Li content. The first active material tends to provide high capacity but also tends to have high resistance, as compared to the second active material. The second active material, which is a positive electrode active material with a low Li content as compared to the first active material, has low capacity and low resistance. In positive electrode plate 1, first layer 11 mainly composed of the first active material constitutes one of the surfaces of active material layer 10 which is farther from current collector 15 than second layer 12 is (hereinafter, this surface is also called “a side of active material layer 10 opposite to the current collector”). Because of this positioning, inside a secondary battery that has positive electrode plate 1, the first active material with higher resistance tends to come into contact with the electrolyte solution. Due to both the porosity of first layer 11 and the porosity of second layer 12 falling within the above-mentioned ranges, both the first active material and the second active material tend to come into contact with the electrolyte solution. Because both the first active material and the second active material tend to come into contact with the electrolyte solution, Li ions tend to diffuse and the charge-discharge reaction in the secondary battery tends to proceed, which can reduce an increase of the resistance of the secondary battery. In addition, because active material layer 10 includes the first active material with high capacity and first layer 11 is mainly composed of the first active material, the secondary battery can have high capacity.

Current collector 15 is a metal foil sheet that is formed with an aluminum material such as aluminum and aluminum alloy, for example.

Active material layer 10 is formed on current collector 15, and includes a positive electrode active material such as the first active material and the second active material. Active material layer 10 may be formed on only one side of current collector 15, or may be formed on both sides. In addition to the positive electrode active material, active material layer 10 includes at least one of a conductive aid and a binder, preferably both a conductive aid and a binder.

The first active material is simply required to be a compound represented by the above-mentioned formula (I). In the formula (I), M1 may include one or more types selected from the group consisting of Co, Al, Mg, Ti, Nb, and Mo, and preferably, it includes Co. In the formula (I), a1 may be 0.11≤a1≤0.3, or may be 0.12≤a1≤0.25, or may be 0.15≤a1≤0.2. In the formula (I), x1 may be 0<x1≤0.4, or may be 0.05≤x1≤0.3, or may be 0.1≤x1≤0.2. In the formula (I), y1 may be 0.50≤y1≤0.68, or may be 0.52≤y1≤0.65, or may be 0.55≤y1≤0.6. In the formula (I), z1 may be 0<z1≤0.2, or may be 0.05≤z1≤0.18, or may be 0.08≤z1≤0.15. The composition of the first active material can be determined by ICP (high-frequency Inductively Coupled Plasma) emission spectroscopy, for example.

The first active material may include two or more lithium-(transition metal) composite oxides that are different in composition, within the range of the composition represented by the formula (I). The first active material may include two or more lithium-(transition metal) composite oxides that are different in at least one of particle shape and particle size. Preferably, the first active material is in the form of secondary particles each consisting of at least 50 primary particles aggregated together. When the first active material is secondary particles of this type, battery performance of the secondary battery such as resistance tends to be enhanced. The particle shape of the first active material, such as, for example, whether it is in the form of secondary particles, can be determined by examining the first active material with a scanning electron microscope (SEM).

The particle size (D50) of the first active material is preferably from 5 to 15 μm, and it may be from 6 to 14 μm, or may be from 7 to 12 μm, or may be from 8 to 11 μm. Herein, the particle size (D50) is a particle size in volume-based particle size distribution at which cumulative frequency of particle sizes accumulated from the small size side reaches 50%. The volume-based particle size distribution can be measured with a laser-diffraction particle size distribution analyzer.

The second active material is simply required to be a compound represented by the above-mentioned formula (II). In the formula (II), M2 may include one or more types selected from the group consisting of Co, Al, Mg, Ti, Nb, and Mo, and preferably, it includes Co. In the formula (II), a2 may be −0.08≤a2≤0.05, or may be −0.07≤a2≤0.03, or may be −0.05≤a2≤0.02, or may be −0.02≤a2≤0.02. In the formula (II), x2 may be 0.52≤x2≤1.0, or may be 0.55≤x2≤0.8, or may be 0.57≤x2≤0.75, or may be 0.6≤x2≤0.7. In the formula (II), y2 may be 0<y2≤0.3, or may be 0.05≤y2≤0.25, or may be 0.1≤y2≤0.23. In the formula (II), z2 may be 0<z2≤0.3, or may be 0.05≤z2≤0.25, or may be 0.1≤z2≤0.23. The composition of the second active material can be determined by ICP (high-frequency Inductively Coupled Plasma) emission spectroscopy, for example.

The second active material may include two or more lithium-(transition metal) composite oxides that are different in composition, within the range of the composition represented by the formula (II). The second active material may include two or more lithium-(transition metal) composite oxides that are different in at least one of particle shape and particle size. Preferably, the second active material is a mixture of [p1] and [p2] described below, and more preferably, the second active material in the second layer is a mixture of [p1] and [p2].
[p1] At least one of single particles and secondary particles, the secondary particles each consisting of 2 to 10 primary particles aggregated together
[p2] Secondary particles each consisting of at least 50 primary particles aggregated together
[p1] may be single particles, or may be secondary particles, or may be a mixture of single particles and secondary particles. Each of [p1] and [p2] mentioned above is a compound represented by the formula (II), and the composition of [p1] and the composition of [p2] may be the same as or different from one another. The particle shape of the second active material, namely, if it has the particle shape of [p1] and [p2] can be determined by examining the second active material with a scanning electron microscope (SEM).

In the second layer, when the second active material is a mixture of [p1] and [p2] mentioned above, the packing density of the second active material in the second layer tends to be enhanced. As a result, the second active material tends to come into contact with another second active material and thereby the resistance of the second layer tends to be reduced, and, at the same time, breakage of the secondary particle of [p2] mentioned above tends to be reduced and thereby endurance of the secondary battery tends to be enhanced. The mixing ratio of [p1] and [p2], which is [p1]: [p2] (in weight), may be from 3:7 to 7:3, or may be from 3.5:6.5 to 6.5:3.5, or may be from 4:6 to 6:4.

The particle size (D50) of [p1] mentioned above is preferably from 1 to 10 μm, and it may be from 2 to 8 μm or may be from 3 to 6 μm. The particle size (D50) of [p2] mentioned above is preferably from 10 to 25 μm, and it may be from 12 to 20 μm or may be from 14 to 18 μm.

Preferably, the particle size (D50) of [p1] mentioned above is smaller than the particle size (D50) of [p2] mentioned above. The particle size (D50) of [p2] of the second active material may be either larger or smaller than the particle size (D50) of the first active material.

The content ratio between the first active material and the second active material in active material layer 10 (in weight), namely, (first active material):(second active material), is simply required to be 2.5:7.5 to 6.5:3.5, preferably it is from 3:7 to 6:4, more preferably from 3:7 to 5:5, and it may be from 3.5:6.5 to 5.5:4.5, or may be from 3.7:6.3 to 5.2:4.8. When the first active material includes two or more lithium-(transition metal) composite oxides, the total amount of them is regarded as the weight of the first active material. When the second active material includes two or more lithium-(transition metal) composite oxides, the total amount of them is regarded as the weight of the second active material. When the content ratio between the first active material and the second active material falls within the above-mentioned range, the secondary battery tends to have both high capacity and low resistance. When the content ratio of the first active material is lower than the above-mentioned range and the content ratio of the second active material is higher than the above-mentioned range, the secondary battery tends not to have high capacity. When the content ratio of the first active material is higher than the above-mentioned range and the content ratio of the second active material is lower than the above-mentioned range, the secondary battery tends to have high resistance.

First layer 11 is simply required to be mainly composed of the first active material. “Being mainly composed of the first active material” refers to including the first active material in a content of 50 weight % or more relative to the total weight of first layer 11. The content of the first active material in first layer 11 may be 60 weight % or more, or may be 70 weight % or more, or may be 80 weight % or more, or may be from 50 to 99 weight %, or may be from 60 to 98 weight %, or may be from 70 to 95 weight %, or may be from 80 to 92 weight %. First layer 11 may include a positive electrode active material other than the first active material, and, for example, it may include the second active material, or it may include a positive electrode active material other than the first active material and the second active material. First layer 11 can further include at least one of a conductive aid and a binder.

Second layer 12 is simply required to be mainly composed of the second active material. “Being mainly composed of the second active material” refers to including the second active material in a content of 50 weight % or more relative to the total weight of second layer 12. The content of the second active material in second layer 12 may be 60 weight % or more, or may be 70 weight % or more, or may be 80 weight % or more, or may be from 50 to 99 weight %, or may be from 60 to 98 weight %, or may be from 70 to 95 weight %, or may be from 80 to 92 weight %. Second layer 12 may include a positive electrode active material other than the second active material, and, for example, it may include the first active material, or it may include a positive electrode active material other than the second active material and the first active material. Second layer 12 may further include at least one of a conductive aid and a binder.

The porosity of first layer 11 is simply required to be from 20 to 45%; it may be from 20 to 42%; it is preferably from 20 to 40%; it may be more than 20% and not more than 40%; it may be from 21 to 45%; and it may be from 25 to 42%. The porosity of second layer 12 is simply required to be from 18 to 41%; it is preferably from 20 to 40%; it may be more than 20% and not more than 40%; it may be from 21 to 41%; and it may be from 25 to 40%. The porosity of first layer 11 may be the same as, or may be different from, the porosity of second layer 12. When the porosity of first layer 11 and that of second layer 12 fall within the above-mentioned ranges, the secondary battery tends to have both high capacity and low resistance. When the porosity of first layer 11 and that of second layer 12 do not fall within the above-mentioned ranges, the secondary battery tends not to have high capacity and low resistance.

The porosity of first layer 11 and that of second layer 12 can be adjusted by changing the amount of the first active material and the second active material to apply for forming active material layer 10, the rate of application, the pressing pressure and the number of pressing operation at the time of rolling a coating layer formed by application of the first active material and the second active material, the particle properties of the first active material and the second active material (the particle size, in particular), the mixing ratio of particles that are different in particle size and/or particle shape, the content of the conductive aid and the binder in first layer 11 and second layer 12, or the like. The porosity of the first layer and that of the second layer can be determined by image analysis of a cross-sectional image of positive electrode plate 1 captured with a scanning electron microscope (SEM).

The thickness of first layer 11 is preferably smaller than the thickness of second layer 12. In the secondary battery, when first layer 11 is thick, the first active material tends not to come into contact with the electrolyte solution; however, when first layer 11 is less thick, the first active material tends to come into contact with the electrolyte solution and thereby lithium ions tend to be easily transferred, and, as a result, resistance of the secondary battery tends to be reduced.

The ratio of the first active material in first layer 11 relative to the total of the first active material in active material layer 10 is preferably from 80 to 100 weight %, more preferably from 90 to 100 weight %, and it may be from 95 to 99 weight %. The ratio of the second active material in second layer 12 relative to the total of the second active material in active material layer 10 is preferably from 80 to 100 weight %, more preferably from 90 to 100 weight %, and it may be from 95 to 99 weight %. This means that a relatively great amount of the first active material may be positioned at a side of active material layer 10 opposite to the current collector and a relatively great amount of the second active material may be positioned at the current collector side of active material layer 10, and, as a result, resistance of the secondary battery tends to be reduced.

Active material layer 10 includes at least first layer 11 and second layer 12. In active material layer 10, first layer 11 constitutes a side of active material layer 10 opposite to the current collector, a side that is farther from the current collector than second layer 12 is, and second layer 12 constitutes a side of active material layer 10 closer to the current collector than first layer 11 is. Preferably, first layer 11 constitutes a surface of active material layer 10 on a side opposite to the side on which current collector 15 is positioned (namely, a side of active material layer 10 opposite to the current collector). Preferably, second layer 12 is in contact with current collector 15. As a result, in the secondary battery, the first active material tends to come into contact with the electrolyte solution and the second active material tends to come into contact with current collector 15, so resistance of the secondary battery tends to be reduced.

Active material layer 10 may have a double-layer structure consisting of first layer 11 and second layer 12, or may have a multilayer structure consisting of three or more layers including another layer other than first layer 11 and second layer 12 (hereinafter, this another layer is also called “an additional layer”). The position of the additional layer in active material layer 10 is not particularly limited, and it may be determined according to the type, content, and the like of the positive electrode active material included in the additional layer. For example, when the additional layer includes the first active material and/or the second active material, the positions of the first layer, the second layer, and the additional layer may be adjusted so that the content of the first active material decreases, or the content of the second active material increases, gradually from a surface of active material layer 10 opposite to current collector 15 toward the current collector 15 side.

Examples of the conductive aid that may be included in active material layer 10, first layer 11, or second layer 12 include a carbon material. The carbon material may be fibrous carbon, graphite, and the like, for example. The graphite may be one or more selected from the group consisting of carbon black (such as acetylene black, Ketjenblack), coke, and activated carbon. The fibrous carbon may be carbon nanotubes (CNTs), for example. The CNTs may be single-walled carbon nanotubes (SWCNTs), or may be multi-walled carbon nanotubes such as double-walled carbon nanotubes (DWCNTs). The conductive aid can include one, two, or more of the above-mentioned conductive aids.

Examples of the binder that may be included in active material layer 10, first layer 11, or second layer 12 include known materials such as, for example, fluororesins such as polyvinylidene difluoride (PVdF) and polytetrafluoroethylene (PTFE); cellulose-based resins such as carboxymethylcellulose (CMC), methylcellulose (MC), and hydroxypropylcellulose; and styrene-butadiene rubber (SBR). The binder can include one, two, or more of the above-mentioned binders.

Positive electrode plate 1 can be produced by, for example, forming second layer 12 and first layer 11 in this order on current collector 15. For example, a second slurry including the second active material is applied to current collector 15, and dried, and thereby a second coating layer is formed. Then, a first slurry including the first active material is applied to the second coating layer, and dried, and thereby a first coating layer is formed. The second coating layer and the first coating layer thus formed sequentially on current collector 15 are compressed, and thereby positive electrode plate 1 can be obtained. The first slurry and the second slurry can include a conductive aid, a binder, and a solvent such as N-methyl-2-pyrrolidone (NMP), in addition to the above-mentioned positive electrode active material.

### (Non-Aqueous Electrolyte Secondary Battery)

A non-aqueous electrolyte secondary battery according to the present embodiment (hereinafter also called “the present battery”) has positive electrode plate 1. As described above, positive electrode plate 1 has active material layer 10 that includes first layer 11 and second layer 12. The present battery can have both high capacity and low resistance.

The present battery can include an electrode assembly including positive electrode plate 1, as well as a non-aqueous electrolyte solution, and it may also have a battery case for accommodating the electrode assembly and the non-aqueous electrolyte solution. The battery case may include an exterior package having an opening, and a sealing plate for sealing the opening. The exterior package and the sealing plate are preferably made of metal, and can be formed with aluminum, aluminum alloy, iron, iron alloy, or the like. Between the electrode assembly and the exterior package, a resin sheet may be provided as an electrode holder. The battery case may be made of a laminated film. The laminated film has a multilayer structure formed of a metal layer and a resin layer stacked on top of one another, for example. The edges of the laminated film can be fused together to form a pouch-shaped battery case.

The electrode assembly may include positive electrode plate 1, a negative electrode plate, and a separator. In the electrode assembly, active material layer 10 of positive electrode plate 1 faces a negative electrode active material layer of the negative electrode plate, with the separator interposed therebetween. The electrode assembly may be a stack-type one that is formed by stacking positive electrode plate 1, the negative electrode plate, and the separator, or may be a wound-type one that is formed by stacking positive electrode plate 1, the negative electrode plate, and the separator and winding the resulting stack. After the stack is wound, the wound-type electrode assembly may be pressed into a flat shape.

The negative electrode plate usually has a negative electrode current collector and a negative electrode active material layer, and the negative electrode current collector is, for example, a metal foil sheet made of a copper material such as copper and copper alloy. The negative electrode active material layer includes a negative electrode active material, and it may further include a conductive aid, a binder, and the like.

Examples of the negative electrode active material include carbon-based active material particles, metal-based active material particles, and the like. Examples of the carbon-based active material particles include particles of one or more types of carbon material selected from the group consisting of graphite such as natural graphite and artificial graphite, hard carbon, soft carbon, and amorphous-coated graphite. Examples of the metal-based active material particles include particles of a metallic element such as an elemental metal or a metal oxide including an element selected from the group consisting of silicon (Si), tin (Sn), antimony (Sb), bismuth (Bi), titanium (Ti), and germanium (Ge). Preferably, examples of the metal-based active material particles include particles of one or more types selected from the group consisting of Si, SiOx (x=0.5 to 1.5), a Si—C composite material (hereinafter also called “a SiC composite”), and Sn.

Examples of the conductive aid include the conductive aids described above as the conductive aid that may be included in active material layer 10. The conductive aid can include one, two, or more of the above-mentioned conductive aids. Examples of the binder include the cellulose-based resins that are described above as the binder that may be included in active material layer 10; polyacrylic acid; styrene-butadiene rubber (SBR); and the like. The binder can include one, two, or more of the above-mentioned binders.

The negative electrode plate can be obtained by, for example, forming the negative electrode active material layer on the negative electrode current collector. For example, a negative electrode composite material slurry including the negative electrode active material is applied to the negative electrode current collector, and dried and compressed, and thereby a negative electrode plate is obtained. The negative electrode composite material slurry can include a conductive aid, a binder, and a solvent such as water, in addition to the above-mentioned negative electrode active material.

The separator has a base material, and it may have a functional layer on at least one side of the base material. The base material can be a porous sheet such as a film or a nonwoven fabric, which is made of a resin such as polyolefin (such as polyethylene and polypropylene), polyester, cellulose, polyamide, and/or the like. The base material may have a monolayer structure, or may have a multilayer structure. Examples of the functional layer include an adhesive layer and a heat-resistant layer, and the functional layer can be either one of them, or both. The adhesive layer can be formed with an adhesive agent, for example. The heat-resistant layer can include a filler and a binder, for example.

The non-aqueous electrolyte solution is preferably obtained by adding an electrolyte to a non-aqueous solvent such as an organic solvent. Examples of the electrolyte include LiPF₆, LiBF₄, LiClO₄, LiFSO₃, LiBOB (lithium bis(oxalato) borate), and the like. The non-aqueous electrolyte solution may include one, two, or more electrolytes among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents among these. The non-aqueous electrolyte solution may further include an additive such as vinylene carbonate (VC), vinylethylene carbonate (VEC), and fluoroethylene carbonate.

### EXAMPLES

In the following, the present disclosure will be described in further detail by way of Examples and Comparative Examples.

### Example 1

### (Preparation of Positive Electrode Plate)

Li_{1.17}Ni_{0.13}Co_{0.13}Mn_{0.57}O₂ as a first active material, graphite as a conductive aid, and polyvinylidene difluoride (PVdF) as a binder were prepared in a ratio (first active material):graphite:PVdF=100:1.5:1 (in weight), and these were mixed with a proper amount of N-methyl-2-pyrrolidone (NMP) to obtain a first slurry. The first active material was secondary particles each consisting of at least 50 primary particles aggregated together.

LiNi_{0.6}Co_{0.2}Mn_{0.2}O₂ as a second active material, graphite as a conductive aid, and polyvinylidene difluoride (PVdF) as a binder were prepared in a ratio (second active material):graphite:PVdF=100:1.5:1 (in weight), and these were mixed with a proper amount of N-methyl-2-pyrrolidone (NMP) to obtain a second slurry. The second active material was a mixture of [p1] and [p2] mentioned above in [p1]: [p2]=1:1, and each of [p1] and [p2] had the above-mentioned composition.

The second slurry was applied to one side of an aluminum foil sheet as a current collector, and dried, to form a second coating layer. Subsequently, the first slurry was applied to the second coating layer, and dried, to form a first coating layer. The second coating layer and the first coating layer thus formed on the current collector were rolled with a rolling mill into predetermined thicknesses; a layer (2) was formed from the second coating layer and a layer (1) was formed from the first coating layer, and thereby a positive electrode plate was obtained. The positive electrode plate has the active material layer on the current collector, and the active material layer has a double-layer structure that has the layer (2) and the layer (1) in this order from the current collector side. The amount of the second slurry and the first slurry to apply was adjusted so as to achieve the content ratio between the first active material and the second active material in the active material layer to become (first active material):(second active material)=3:7.

### (Preparation of Battery (1) for Specific Capacity Measurement)

The positive electrode plate obtained in the above-mentioned manner and a metal lithium foil sheet as a counter electrode for the positive electrode plate were cut into predetermined dimensions. A double-layer separator that had a heat-resistant layer on one side of a polyethylene base material was prepared. The positive electrode plate, the separator, and the metal lithium foil sheet were stacked together to obtain an electrode assembly. The aluminum foil sheet of the positive electrode plate is exposed on the electrode assembly. The positive electrode plate and the separator were stacked together so that the active material layer of the positive electrode plate and the heat-resistant layer of the separator were in contact with each other. The aluminum foil sheet of the positive electrode plate of the electrode assembly was welded to an aluminum plate for external current collection, and the metal lithium foil sheet of the electrode assembly was welded to a copper plate for external current collection, followed by inserting the electrode assembly into an exterior package made of an aluminum laminated film, and fusing the film in such a manner that a liquid inlet was to be formed. A non-aqueous electrolyte solution was injected through the liquid inlet, and then the liquid inlet was sealed, to obtain a battery (1).

The non-aqueous electrolyte solution was prepared by dissolving lithium hexafluorophosphate (LiPF₆) as an electrolyte in a concentration of 1.15 mol/L in a mixed solvent of ethylene carbonate (EC), ethyl methyl carbonate (EMC), and dimethyl carbonate (DMC) (EC:EMC:DMC-3:3:4 in volume).

### (Preparation of Battery (2) for Resistance Measurement)

A battery (2) was obtained according to the procedure for the preparation of the battery (1) except that instead of the metal lithium foil sheet, as a counter electrode for the positive electrode plate, a negative electrode plate having a graphite-containing active material layer was used.

### Example 2

A positive electrode plate, a battery (1), and a battery (2) were prepared according to the procedure described in Example 1 except that the amount of the second slurry and the first slurry to apply was changed so that the content ratio between the first active material and the second active material in the active material layer became the content ratio specified in Table 1.

### Comparative Example 1

The second slurry prepared according to the procedure described in Example 1 was applied to an aluminum foil sheet as a current collector, and dried, followed by rolling the resultant into a predetermined thickness, and thus a positive electrode plate was obtained. The resulting positive electrode plate has a monolayered active material layer on the current collector, and the active material layer contains the second active material. Except that the positive electrode plate thus obtained was used, the procedure described in Example 1 was adopted to prepare a battery (1) and a battery (2).

### Comparative Example 2

The first slurry prepared according to the procedure described in Example 1 was applied to an aluminum foil sheet as a current collector, and dried, followed by rolling the resultant into a predetermined thickness, and thus a positive electrode plate was obtained. The resulting positive electrode plate has a monolayered active material layer on the current collector, and the active material layer contains the first active material. Except that the positive electrode plate thus obtained was used, the procedure described in Example 1 was adopted to prepare a battery (1) and a battery (2).

### Comparative Example 3

Li_{1.17}Ni_{0.13}Co_{0.13}Mn_{0.57}O₂ as a first active material, LiNi_{0.6}Co_{0.2}Mn_{0.2}O₂ as a second active material, graphite as a conductive aid, and polyvinylidene difluoride (PVdF) as a binder were prepared in a ratio (first active material):(second active material):graphite:PVdF=30:70:1.5:1 (in weight), and these were mixed with a proper amount of N-methyl-2-pyrrolidone (NMP) to obtain a slurry. The first active material was secondary particles each consisting of at least 50 primary particles aggregated together, and the second active material was a mixture of [p1] and [p2] mentioned above in [p1]: [p2]=1:1, and each of [p1] and [p2] had the above-mentioned composition of the second active material. The resulting slurry was applied to an aluminum foil sheet as a current collector, and dried, followed by rolling the resultant into a predetermined thickness, and thus a positive electrode plate was obtained. Except that the positive electrode plate thus obtained was used, the procedure described in Example 1 was adopted to prepare a battery (1) and a battery (2).

### Comparative Examples 4 and 5

A positive electrode plate, a battery (1), and a battery (2) were prepared according to the procedure described in Example 1 except that the amount of the second slurry and the first slurry to apply was changed so that the content ratio between the first active material and the second active material in the active material layer became the content ratio specified in Table 1.

### Comparative Example 6

The first slurry and the second slurry were prepared according to the procedure described in Example 1. The first slurry was applied to an aluminum foil sheet as a current collector, and dried, to form a first coating layer. Subsequently, the second slurry was applied to the first coating layer, and dried, to form a second coating layer. The first coating layer and the second coating layer thus formed on the current collector were rolled with a rolling mill into predetermined thicknesses; a layer (1) was formed from the first coating layer and a layer (2) was formed from the second coating layer, and thereby a positive electrode plate was obtained. The positive electrode plate has the active material layer on the current collector, and the active material layer has a double-layer structure that has the layer (1) and the layer (2) in this order from the current collector side. The amount of the first slurry and the second slurry to apply was adjusted so as to achieve the content ratio between the first active material and the second active material in the active material layer to become (first active material):(second active material)=3:7.

Except that the positive electrode plate thus obtained was used, the procedure described in Example 1 was adopted to prepare a battery (1) and a battery (2).

### Comparative Examples 7 and 8

A positive electrode plate, a battery (1), and a battery (2) were prepared according to the procedure in Example 1 except that the conditions of rolling the second coating layer and the first coating layer with a rolling mill were changed and the porosity of each layer was changed.

### [Calculation of Porosity]

The positive electrode plate was cut in the thickness direction, and in this cross section, scanning electron microscope (SEM) images of the active material layer were captured at five or more points. Each of the SEM images thus captured was subjected to image analysis for binarization into pore parts and a non-pore part, and for each layer constituting the active material layer, the area fraction of the total area Sv of pores in the layer to the total area St of the layer ((Sv/St)×100[%]) was calculated. The area fractions calculated for all the SEM images were averaged, and the resulting value was regarded as the porosity [%]. Results are given in Table 1.

### [Measurement of Specific Capacity]

Under conditions at a temperature of 25° C., a charge-discharge tester was used to charge the battery (1) at a current of 0.1 C to reach an upper limit voltage of 4.7 V. After 10 minutes of resting, the battery (1) was discharged at a current of 0.05 C to reach a lower limit voltage of 2.5 V. The discharged capacity [mAh] at this time was divided by the weight [g] of the active material included in the active material layer of the positive electrode plate to obtain the specific capacity [mAh/g].

### [Measurement of Resistance]

Under conditions at a temperature of 25° C., the battery (2) was charged at a current of 0.33 C to reach a state of charge (SOC) of 7%. After 10 minutes of resting, discharging was carried out at a current of 0.33 C for 10 seconds, and the voltage and the value of current for discharging were measured after a lapse of 0.1 seconds and 10 seconds from the start of discharging. Subsequently, charging was carried out at a current of 0.33 C for 10 seconds. The voltage and the value of current were measured according to the above-mentioned manner except that the current rate was changed to 0.5 C, 1 C, and 1.5 C. From the voltage and the value of current obtained at each current rate, the discharge resistance from the 0.1-second time point to the 10-second time point following the start of discharging was calculated.

The above-mentioned manner was carried out at a state of charge (SOC) of 50% and 90%, and the discharge resistance was calculated according to the above-mentioned manner. The discharge resistances at all the SOCs (7%, 50%, and 90%) were averaged. With the average discharge resistance in Comparative Example 1 defined as 1, the average discharge resistance in each Example or Comparative Example was calculated as a relative ratio to the average discharge resistance in Comparative Example 1, and the resultant was regarded as the resistance in the Example or Comparative Example. Results are given in Table 1.

### [Observation of Particle Shape, Measurement of Particle Size (D50)]

The first active material or the second active material was dispersed in about 1 g of water to prepare a test sample. The test sample was introduced into a laser-diffraction particle size distribution analyzer (“MT3000II” manufactured by MicrotracBEL Corp.) to obtain volume-based particle size distribution. In the volume-based particle size distribution, the particle size (D50) at which cumulative frequency of particle sizes accumulated from the small size side reached 50% was measured. Results are given in Table 2.

TABLE 1

| | Active material layer | | | | | | | |
|---|---|---|---|---|---|---|---|---|
| | | Type of | | Porosity of | | | | |
| | | active material | | layer [%] | | | | |
| | | Opposite | | Opposite | | Active | | |
| | | side to | Current | side to | Current | material | Specific | |
| | | current | collector | current | collector | content | capacity | |
| | Structure | collector | side | collector | side | ratio*¹ | [mAh/g] | Resistance |
| Ex. 1 | Double layer | First active | Second active | 40 | 21 | 3:7 | 212 | 1.08 |
| | | material | material | | | | | |
| Ex. 2 | Double layer | First active | Second active | 40 | 21 | 6:4 | 237 | 1.29 |
| | | material | material | | | | | |
| Comp. | Monolayer | Second active material | | 21 | | — | 187 | 1.00 |
| Ex. 1 | | | | | | | | |
| Comp. | Monolayer | First active material | | 40 | | — | 270 | 1.60 |
| Ex. 2 | | | | | | | | |
| Comp. | Monolayer | First active material and | | 27 | | 3:7 | 210 | 1.30 |
| Ex. 3 | | second active material | | | | | | |
| Comp. | Double layer | First active | Second active | 40 | 21 | 2:8 | 204 | 1.02 |
| Ex. 4 | | material | material | | | | | |
| Comp. | Double layer | First active | Second active | 40 | 21 | 7:3 | 245 | 1.42 |
| Ex. 5 | | material | material | | | | | |
| Comp. | Double layer | Second active | First active | 21 | 40 | 3:7 | 207 | 1.47 |
| Ex. 6 | | material | material | | | | | |
| Comp. | Double layer | First active | Second active | 18 | 15 | 3:7 | 208 | 1.33 |
| Ex. 7 | | material | material | | | | | |
| Comp. | Double layer | First active | Second active | 48 | 42 | 3:7 | 206 | 1.50 |
| Ex. 8 | | material | material | | | | | |

*¹Active material content ratio refers to (first active material):(second active material) (in weight).

TABLE 2

| | | Particle size (D50) [μm] |
|---|---|---|
| First active material | | 9.5 |
| Second active material | [p1] | 4.0 |
| | [p2] | 16.3 |

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode plate comprising:
a current collector; and
an active material layer provided on the current collector, wherein
the active material layer has
a first layer mainly composed of a first active material represented by a formula (I) below, and
a second layer mainly composed of a second active material represented by a formula (II) below, the second layer is positioned closer to the current collector than the first layer is,
a content ratio between the first active material and the second active material in the active material layer is (first active material):(second active material)=2.5:7.5 to 6.5:3.5 (in weight),
a porosity of the first layer is from 20 to 45%, and
a porosity of the second layer is from 18 to 41%: 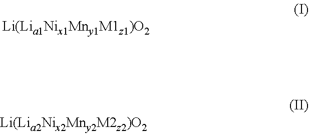
where
M1 and M2 are independently one or more metallic elements selected from the group consisting of Co, Al, Mg, Ca, Ti, V, Cr, Fe, Cu, Zn, Zr, Nb, Mo, Ta, and W,
0.1≤a1≤0.33, 0≤x1≤0.5, 0.5≤y1≤0.7, 0≤z1≤0.2, and a1+x1+y1+z1=1 are satisfied, and,
−0.1≤a2≤0.1, 0.5≤x2≤1, 0≤y2≤0.3, 0≤z2≤0.3, and a2+x2+y2+z2=1 are satisfied.

2. The positive electrode plate according to claim 1, wherein the content ratio between the first active material and the second active material in the active material layer is (first active material):(second active material)=3:7 to 6:4 (in weight).

3. The positive electrode plate according to claim 1, wherein the content ratio between the first active material and the second active material in the active material layer is (first active material):(second active material)=3:7 to 5:5 (in weight).

4. The positive electrode plate according to claim 1, wherein each of the porosity of the first layer and the porosity of the second layer is from 20 to 40%.

5. The positive electrode plate according to claim 1, wherein the first layer constitutes a surface of the active material layer on a side opposite to a side on which the current collector is positioned.

6. The positive electrode plate according to claim 1, wherein the second layer is in contact with the current collector.

7. The positive electrode plate according to claim 1, wherein the second active material is a mixture of [p1] below and [p2] below:
[p1] at least one of single particles and secondary particles, the secondary particles each consisting of 2 to 10 primary particles aggregated together; and
[p2] secondary particles each consisting of at least 50 primary particles aggregated together.

8. A non-aqueous electrolyte secondary battery comprising the positive electrode plate according to claim 1.
